(19) United States
(12) Patent Application Publication
(10) Pub. No.: US 2005/0210732 A1
(43) Pub. Date: Sep. 29, 2005

(54) Crank bait tail

(76) Inventor: John W. Guerin, Kennedale, TX (US)

Correspondence Address: MICHAEL L. DIAZ, P.C., 555 REPUBLIC DRIVE, SUITE 200, PIANO, TX, 75074, US

(21) Appl. No.: 10/810,524

(22) Filed: Mar. 26, 2004

(51) Int. Cl. A01K 85/00

(52) U.S. Cl. 43/42.28

(57) ABSTRACT

A tail for use on crank bait is disclosed. The tail includes a concentric base having an opening. A plurality of strands are attached to the concentric base. The tail is affixed to a rearwardly mounted eye on the crank bait. A split ring and associated hook are then attached to the eye. The tail is held in place by the split ring. The strands provide a counteracting movement corresponding to a forward movement of the crank bait.

### BACKGROUND OF THE INVENTION

1. Technical Field of the Invention

This invention relates to artificial fishing lures, and more particularly, to a tail attached to an artificial fishing lure.

2. Description of Related Art

Artificial bait or lures simulate nature or live species such as insects, amphibians, and fish. There are many types of artificial baits utilized by fishermen. Artificial baits include animated lures useful in casting and suspended fishing methods, imitating the movements of the live natural prey of game fish. The more natural the movement of the artificial bait, the higher likelihood that a fish will take the bait. One of the most important features of an effective artificial bait is the movement of the bait through the water. Although there are many existing devices which appear as artificial bait, there are no add-on existing devices which simulate the movement of the fish through water through the movement of a tail on a back portion of the bait.

An artificial bait is needed which simulates the movement of a fish traveling through the water without engaging in costly modifications of existing artificial bait. Thus, it would be a distinct advantage to have such an accessory for attachment to artificial bait. It is an object of the present invention to provide such a device.

### SUMMARY OF THE INVENTION

In one aspect, the present invention is a tail for attachment to any standard crank bait. The tail includes a substantially concentric base and a plurality of strands affixed to the concentric base. The concentric base is affixed to an eye located on a back portion of the crank bait. A split ring and hook is then attached to the eye. The tail provides movement of the plurality of strands as the crank bait moves through water.

In another aspect, the present invention is a crank bait for use in attracting fish. The crank bait includes a rearwardly mounted eye and a bill mounted on a forward portion of the crank bait. The crank bait also includes a tail having a concentric base with a plurality of strands. The tail is affixed to the rearwardly mounted eye. A split ring and hook are then attached to the eye, thereby holding the tail in place on the crank bait. The tail provides movement of the plurality of strands as the crank bait moves through water, thereby providing an appearance of a fish moving through the water.

In still another aspect, the present invention is a tail for attachment to a lipless crank bait. The tail includes at least two cycle strands and a base section upon which the strands are attached. The base section is affixed to the lipless crank bait. As the lipless crank bait moves through the water, the cycle strands spiral through the water.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 (prior art) is a side view of an existing crank bait;

FIG. 2 (prior art) is a side partial view of the rear portion of the crank bait and a detached hook;

FIG. 3 is a side view of an attachable tail affixed to the crank bait in the preferred embodiment of the present invention;

FIG. 4 is a side view of the attachable tail removed from the crank bait of FIG. 3;

FIG. 5 is a top view of the attachable tail detached from the crank bait; and

FIG. 6 is a side view of a cycle tail0 attached to a lipless crank bait in an alternate embodiment of the present invention.

### DETAILED DESCRIPTION OF EMBODIMENTS

A tail for attachment to an artificial crank bait is disclosed. FIG. 1 is a side view of an existing crank bait 12. An eye 18 is affixed to a rear portion 19 of the crank bait 12. The crank bait includes a front portion 20 having a bill 22. At the top or front of the crank bait is a split ring 24 for attachment to a fishing line 26. At the bottom portion is a hook 28. In addition, there is typically a hook 30 located on a rear split ring 32. The rear split ring 32 is attached to the eye 18. The placement and number of hooks are illustrative only. It should be understood that there are a vast number of baits with various types of hook locations and number.

The crank bait 12 is pulled through the water by a fisherman. As the crank bait is pulled, the bill 22 enables the crank bait to move in a “wobbling” fashion through the water. The hooks are used for capturing fish.

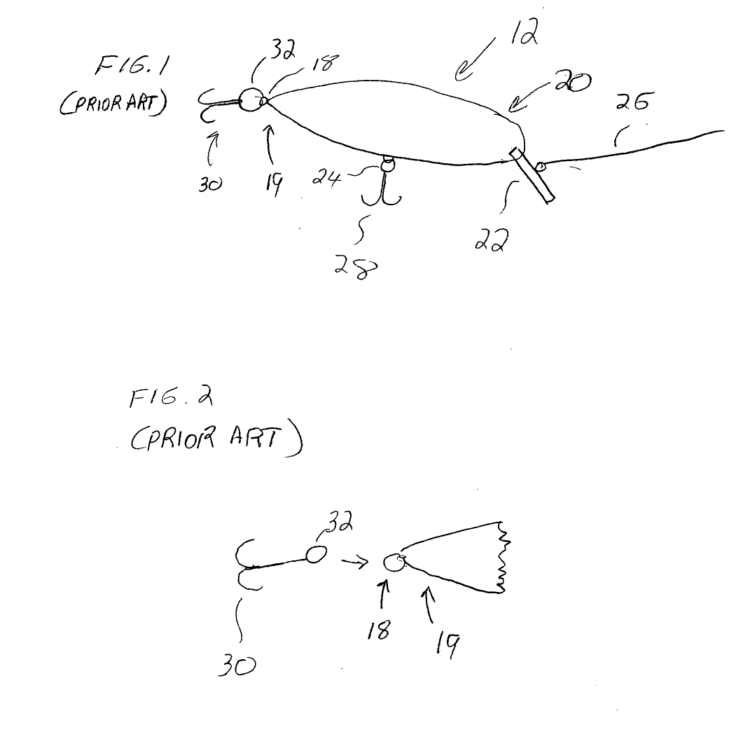

FIG. 2 is a side partial view of the rear portion 19 of the crank bait 12 and a detached hook 30. As illustrated, the hook is typically affixed to the split ring 32. The split ring is then affixed to the eye 18.

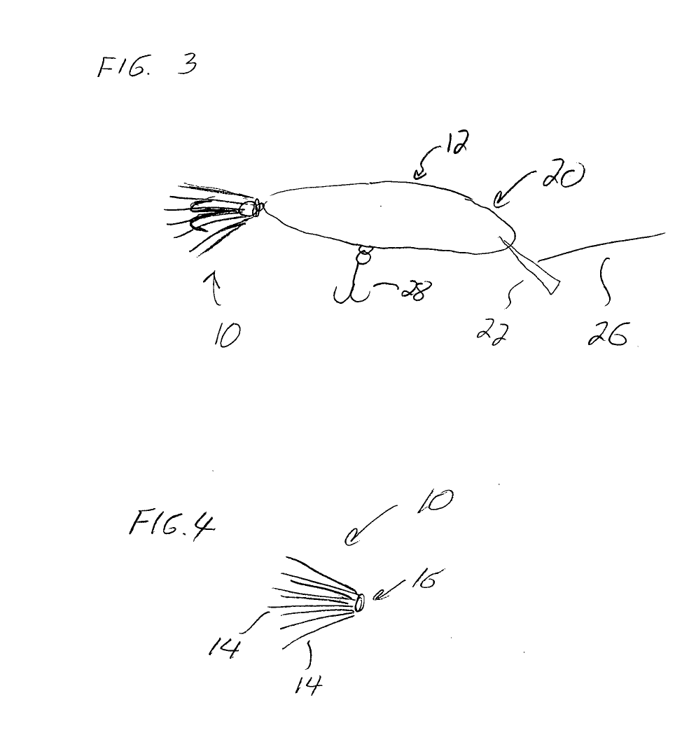

FIG. 3 is a side view of an attachable tail 10 affixed to the crank bait 12 in the preferred embodiment of the present invention. The tail is configured with a plurality of longitudinally aligned strands 14. The strands are affixed to a concentric base 16. The concentric base is attached to the eye 18 on the back portion 18 of the crank bait 12.

FIG. 4 is a side view of the attachable tail 10 removed from the crank bait 12 of FIG. 3. The strands 14 may be any size and shape but preferably are arranged in a shape of a cone and of a length to conceal the hook 30 when affixed to the crank bait 12.

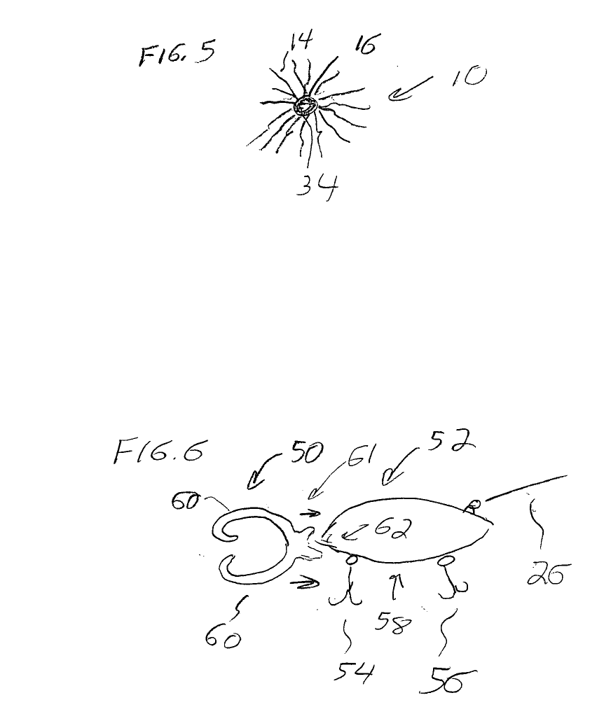

FIG. 5 is a top view of the attachable tail 10 detached from the crank bait 12. The concentric base 16 includes a centrally located opening 34. The tail may be constructed of any flexible yet resilient material, such as a rubber or silicon-based material. In the preferred embodiment of the present invention, the strands are of sufficient length to cover the hook 30. The strands radiate outwardly and downwardly from the concentric base 16, preferably in a conical shape. The concentric base is preferably constructed of the same rubber or silicon-based material and has elastomeric characteristics.

With reference to FIGS. 1-5, the operation of the tail 10 will now be explained. The tail is affixed by threading the eye 18 through the opening 34, then attaching the rear split ring 32 through the eye 18, thus holding the tail in place. As discussed above, the concentric base is elastomeric, thus enabling the opening to be enlarged to accommodate passage over the eye 18 through the opening 34. Upon passage of the eye through the opening, the opening constricts to a smaller size. With the opening constricted, the tail is held in place to the back portion 19 of the crank bait. After threading the eye through the opening 34 of the tail 10, the split ring 32 and associated hook 30 are attached to eye. With the split ring 32 in place upon the eye 18, the tail is prevented from detaching from the eye 18.

The crank bait is attached to the fishing line 26 which is, in turn, attached to a fishing rod. As the fisherman moves the crank bait 12 through the water, the bait “wobbles” back and forth. As the crank bait is moved through the water, the tail moves in the opposite direction of the “wobble.” For each movement from the front of the crank bait, the tail moves in a counteraction of the forward movement. Specifically, the plurality of strands individually move in a substantially general direction. This counteraction provides a very realistic simulation of a fish swimming through water. As the crank bait moves through the water, the strands which form the tail all move generally together in an opposite direction.

The present invention is preferably utilized with a crank bait having a bill. The bill provides the diving depth and amount of “wobble” of the crank bait, thus enabling a counteraction of the tail. However, the tail may be used with any artificial lure having a split ring for holding a hook. In addition, the tail may be positioned on any portion of the bait to provide additional attraction as the bait travels through water. In addition, more than one tail may be utilized for one lure.

FIG. 6 is a side view of a cycle tail 50 attached to a lipless crank bait 52 in an alternate embodiment of the present invention. The cycle tail may be utilized on a lipless crank bait. A lipless crank bait does not have a bill. Typically, two hooks 54 and 56 are affixed to a bottom portion 58 of the crank bait 52. The crank bait 52 is pulled by the fishing line 26. The cycle tail includes at least two cycle strands 60 attached to a base section 61. In this embodiment, the cycle strands are biased to have an inward curve. The cycle tail is preferably constructed of a soft plastic, resilient yet very flexible. The base is preferably constructed to conform to the rear portion of the crank bait. The cycle tail 50 is affixed to a rear portion 62 of the crank bait by applying the base section directly to the rear portion 62 of the crank bait 52. Preferably, the cycle tail is affixed with a strong glue to the very rearward-most portion of the crank bait 52. However, any attaching means may be utilized to hold the cycle tail in place upon the crank bait. Additionally, the cycle tail is positioned on the rear of the crank bait so that as the crank bait is pulled by the fisherman, the cycle tail and its associated cycle strands are in the same axis as the movement of the crank bait 52 through the water.

As the crank bait 52 is pulled through the water, the cycle strands 60 spiral through the water. The cycle strands spiral through the water because of the curved bias of the strands. The strands may be biased by constructing the strands in a mold where the strands are curved. The spiraling cycle strands, through their movement through the water, attract fish by the movement and vibration caused by the movement of the cycle strands 60.

The present invention provides many advantages over existing artificial baits. First, the tail provides an extremely realistic simulation of a fish traveling through water. With each forward motion of the crank bait, the tail moves in an opposite direction. This movement of the tail provides an appearance of a fish swimming though the water. The tail may be used on any existing artificial baits. Rather than creating an entirely new lure, the present invention may be easily affixed to an existing lure. The tails may be made in multiple sizes.

It is thus believed that the operation and construction of the present invention will be apparent from the foregoing description. While the device shown and described has been characterized as being preferred, it will be readily apparent that various changes and modifications could be made therein without departing from the scope of the invention as defined in the following claims.

1: A crank bait and tail combination, said combination comprising:
a crank bait having a main body, an eye, and a bill;
a tail attached to the crank bait, said tail having:
a substantially concentric base; and
a plurality of strands affixed to said concentric base;
said concentric base being affixed through the eye to the crank bait and said tail providing a counteracting movement from the main body of the plurality of strands as the crank bait moves through water.

2: The crank bait and tail combination of claim 1 wherein said concentric base includes an opening having elastomeric characteristics and said concentric base being enlarged to accommodate passage over the eye and constricted upon the eye, thereby holding said concentric base in place upon the eye.

3: The crank bait and tail combination of claim 2 further comprising a split ring and a hook; and
wherein the split ring is attached to the eye upon passage of the concentric base over the eye and the hook is attached to the split ring, thereby preventing the tail from detaching from the crank bait.

4: The crank bait and tail combination of claim 1 wherein the tail provides a counteracting motion corresponding to each forward motion of the main body of the crank bait.

5: A crank bait for use in attracting fish, the crank bait comprising:
a crank bait having a main body and a rearwardly mounted eye;
a bill mounted on a forward portion of the main body of the crank bait; and
a tail having a concentric base with a plurality of strands, said tail being affixed over the rearwardly mounted eye to the crank bait;
said tail providing a counteracting movement of the plurality of strands as the main body of the crank bait moves through water, thereby providing an appearance of a fish moving through the water.

6: The crank bait of claim 5 wherein said concentric base includes an opening having elastomeric characteristics and said concentric base being enlarged to accommodate passage of the eye and constricted upon passage of the eye through the opening, thereby holding said concentric base in place against the eye.

7: The crank bait of claim 6 further comprising a split ring having an attached hook and wherein said split ring and hook is attached to the eye after attachment of said tail.

8: The crank bait of claim 5 wherein said tail provides a counteracting motion corresponding to each forward motion of the main body of the crank bait.

9: A tail for attachment to a lipless crank bait, the tail comprising:
a lipless crank bait;
at least two cycle strands; and
a base section, said cycle strands affixed to said base section and said base section being affixed to the lipless crank bait;
whereby said cycle strands spiral through water upon movement of the lipless crank bait movement through the water.

10: The tail for attachment to a lipless crank bait of claim 9 wherein each cycle strand is biased to a curved shape.
